(19) United States
(12) Patent Application Publication
(10) Pub. No.: US 2026/0039075 A1
(43) Pub. Date: Feb. 5, 2026

(54) BUSBAR ARRANGEMENT STRUCTURE

(71) Applicant: YAZAKI CORPORATION, Tokyo (JP)

(72) Inventors: Ryota KATAOKA, Shizuoka (JP); Ryosuke MURATA, Shizuoka (JP)

(73) Assignee: YAZAKI CORPORATION, Tokyo (JP)

(21) Appl. No.: 19/285,001

(22) Filed: Jul. 30, 2025

(30) Foreign Application Priority Data
Aug. 5, 2024 (JP) 2024-128883

(51) Int. Cl. H01R 25/16; H01R 9/22; H01R 13/50

(52) U.S. Cl. CPC H01R 25/162; H01R 9/226; H01R 13/50

(57) ABSTRACT

A busbar arrangement structure includes a busbar arrangement case including a case body, side walls, and a leg portion, a first busbar including a first body portion configured to be arranged along a first inner wall surface of the case body and a first bent piece that is provided on a lower end of the first body portion, and a second busbar including a second body portion configured to be arranged along a second inner wall surface that is provided beside the first inner wall surface extending in the upper-lower direction and a second bent piece that is provided on a lower end of the second body portion. A step is formed at a boundary between the first inner wall surface and the second inner wall surface that is farther from an outer wall surface of the case body than the first inner wall surface.

### CROSS-REFERENCE TO RELATED APPLICATIONS

This application is based on and claims priority under 35 USC 119 from Japanese Patent Application No. 2024-128883 filed on Aug. 5, 2024, the entire content of which is incorporated herein by reference.

### TECHNICAL FIELD

The present disclosure relates to a busbar arrangement structure.

### BACKGROUND ART

In the related art, in a vehicle such as an automobile, an electric junction box, a terminal block, or an inter-stack arrangement module that electrically connects battery stacks, and the like have been known as a component including a busbar arrangement structure. The busbar arrangement structure includes busbar circuit members and a case. Each of the busbar circuit members includes a plate-shaped busbar (flat conductor) having a predetermined width. The case holds these busbar circuit members as disclosed in JP2023-077016A, JP2022-148361A, and JP2019-068631A.

FIG. 6 is a perspective view showing an inter-stack arrangement module 501. The inter-stack arrangement module 501 includes a busbar arrangement case 511, and a first busbar 531 and a second busbar 541 that are inserted into the busbar arrangement case 511 from above.

The busbar arrangement case 511 includes a rectangular plate-shaped case body 513, side walls 515 that extend in an upper-lower direction and that are provided on both side edges of the case body in a manner of being perpendicular to the side edges, and a box-shaped leg portion 517 provided at a lower end of the case body 513.

Each of the first busbar 531 and the second busbar 541 includes a body portion 533, 543 arranged along an inner wall surface 514 of the case body 513, and a bent piece 535, 545 that is provided on a lower end of the body portion 533, 543 in a manner of being perpendicular to the lower end and that is placed on an inner bottom surface of the leg portion 517. The first busbar 531 and the second busbar 541 are inserted into the busbar arrangement case 511 from above and are arranged.

Screw insertion holes 537, 547 and 539, 549 for screw fastening to a plurality of mating busbars (not shown) are formed in an upper portion of the body portion 533, 543 and the bent piece 535, 545, respectively. Positions of the screw insertion holes 537, 547 and 539, 549 in the first busbar 531 and the second busbar 541 are set according to positions of the corresponding mating busbars.

A partition wall 512 that secures an insulation distance between the first busbar 531 and the second busbar 541 is provided on the inner wall surface 514 of the case body 513 and the inner bottom surface of the leg portion 517.

However, as shown in FIG. 7, there is a problem that a sufficient insulation distance between upper adjacent portions of the first busbar 531 and the second busbar 541 that are arranged on the inner wall surface 514 in the busbar arrangement case 511 cannot be secured because a distance S2 between the upper adjacent portions is short.

That is, since the positions of the screw insertion holes 537, 547 and 539, 549 for screw fastening to the mating busbars are set in consideration of ease of assembly and securing clearance with a component in a battery pack, each of the first busbar 531 and the second busbar 541 has, when viewed from the front, an inverted L-shape in which a portion is widened in order to secure a screw fastening surface.

Therefore, when a partition wall is provided between the upper adjacent portions of the first busbar 531 and the second busbar 541, the second busbar 541 inserted into the busbar arrangement case 511 from above cannot be arranged. Therefore, it is impossible to secure the insulation distance between the upper adjacent portions of the first busbar 531 and the second busbar 541 by providing the partition wall on the inner wall surface 514 of the case body 513.

When the second busbar 541 is to be inserted from above in a state in which the first busbar 531 is already arranged in the busbar arrangement case 511, the bent piece 545 of the second busbar 541 interferes with the first busbar 531 and cannot be arranged. Therefore, there is also a problem that an arrangement order in which the second busbar 541 needs to be arranged first in the busbar arrangement case 511 is limited.

### SUMMARY OF INVENTION

The present disclosure provides a busbar arrangement structure capable of easily securing an insulation distance between adjacent busbars.

A busbar arrangement structure includes a busbar arrangement case including a rectangular plate-shaped case body, side walls that extend in an upper-lower direction and that are provided on both side edges of the case body in a manner of being perpendicular to the side edges, and a box-shaped leg portion provided on a lower end of the case body, a first busbar including a first body portion configured to be arranged along a first inner wall surface of the case body, and a first bent piece that is provided on a lower end of the first body portion in a manner of being perpendicular to the lower end and that is configured to be placed on an inner bottom surface of the leg portion, the first busbar being inserted into the busbar arrangement case from above, and a second busbar including a second body portion configured to be arranged along a second inner wall surface that is provided beside the first inner wall surface extending in the upper-lower direction in a manner of being side by side with the first inner wall surface, and a second bent piece that is provided on a lower end of the second body portion in a manner of being perpendicular to the lower end and that is configured to be placed on an inner bottom surface of the leg portion, the second busbar being inserted into the busbar arrangement case from above. A step is formed at a boundary between the first inner wall surface and the second inner wall surface that is farther from an outer wall surface of the case body than the first inner wall surface.

According to the busbar arrangement structure according to the present disclosure, an insulation distance between adjacent busbars can be easily secured.

The present disclosure has been briefly described above. Further, the details of the present disclosure can be clarified by reading a mode (hereinafter, referred to as an “embodiment”) for carrying out the disclosure to be described below with reference to the accompanying drawings.

### BRIEF DESCRIPTION OF DRAWINGS

FIG. 1 is a perspective view of an inter-stack arrangement module including a busbar arrangement structure according to an embodiment of the present disclosure;

FIG. 2 is a perspective view of a busbar arrangement case shown in FIG. 1;

FIG. 3 is a partial front view of the inter-stack arrangement module shown in FIG. 1;

FIG. 4 is a plan view of the inter-stack arrangement module shown in FIG. 1;

FIG. 5 is a perspective view for explaining an arrangement procedure of the busbar with respect to the inter-stack arrangement module;

FIG. 6 is a perspective view of an inter-stack arrangement module having a busbar arrangement structure in the related art; and

FIG. 7 is a partial front view of the inter-stack arrangement module shown in FIG. 6.

### DESCRIPTION OF EMBODIMENTS

Hereinafter, an embodiment of the present disclosure will be described with reference to the drawings.

The busbar arrangement structure according to the present embodiment can be suitably used for, for example, an inter-stack arrangement module. In addition, the busbar arrangement structure can be used for a terminal block, an electric junction box, or the like that electrically connects a battery assembly and a control device such as an inverter.

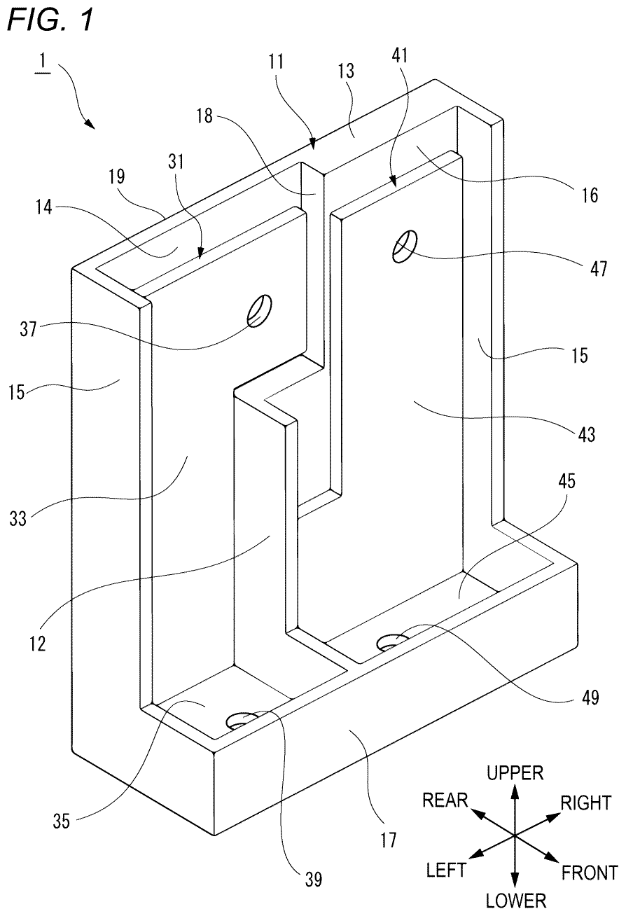

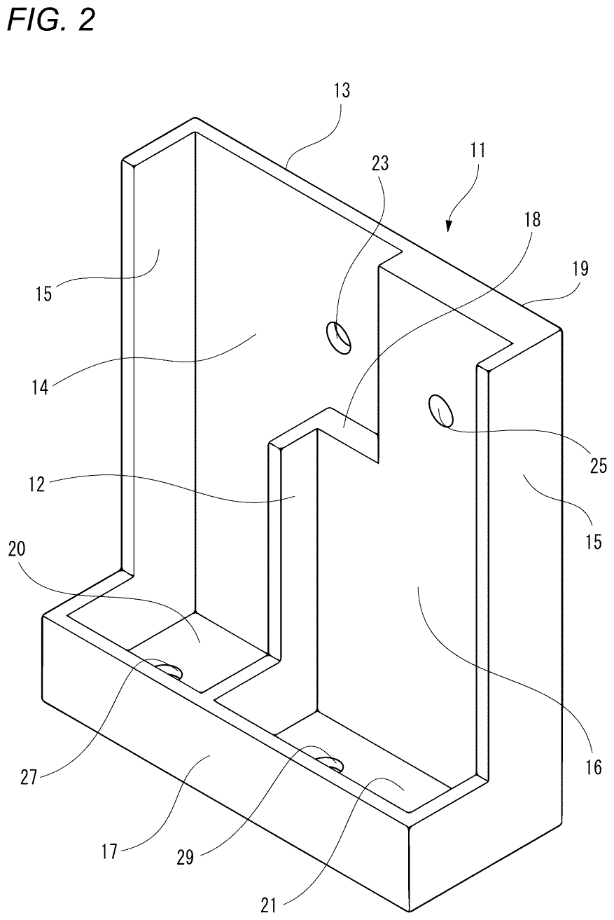

FIG. 1 is a perspective view of an inter-stack arrangement module 1 including a busbar arrangement structure according to an embodiment of the present disclosure. FIG. 2 is a perspective view of a busbar arrangement case shown in FIG. 1. In the present embodiment, upper-lower, front-rear, and left-right directions in the inter-stack arrangement module 1 follow upper-lower, front-rear, and left-right directions indicated by arrows shown in FIG. 1.

As shown in FIGS. 1 and 2, the inter-stack arrangement module 1 including the busbar arrangement structure according to the present embodiment includes a busbar arrangement case 11, a first busbar 31, and a second busbar 41 as main components.

As shown in FIG. 2, the busbar arrangement case 11 is integrally formed of an electrically insulating synthetic resin. The busbar arrangement case 11 includes a rectangular plate-shaped case body 13, side walls 15 that extend in the upper-lower direction and that are provided on both side edges of the case body 13 in a manner of being perpendicular to the side edges, and a box-shaped leg portion 17 provided at a lower end of the case body 13.

The case body 13 has a first inner wall surface 14 and a second inner wall surface 16. The first inner wall surface 14 on a left side extends in the upper-lower direction. The second inner wall surface 16 on a right side is arranged side by side with the first inner wall surface 14 and is farther from an outer wall surface 19 of the case body 13 than the first inner wall surface 14. Therefore, a step 18 is formed at a boundary between the second inner wall surface 16 and the first inner wall surface 14. A height of the step 18 is preferably larger than a plate thickness of a first body portion 33 of the first busbar 31.

As shown in FIG. 1, the first busbar 31 includes the first body portion 33 arranged along the first inner wall surface 14 of the case body 13, and a first bent piece 35 that is provided on a lower end of the first body portion 33 in a manner of being perpendicular to the lower end and that is placed on an inner bottom surface 20 of the leg portion 17. Screw insertion holes 37 and 39 for screw fastening to a plurality of mating busbars (not shown) are formed in an upper portion of the first body portion 33 and the first bent piece 35, respectively.

The second busbar 41 includes a second body portion 43 arranged along the second inner wall surface 16 that is arranged on the right side of the first inner wall surface 14 extending in the upper-lower direction in a manner of being side by side with the first inner wall surface 14, and a second bent piece 45 that is provided on a lower end of the second body portion 43 in a manner of being perpendicular to the lower end and that is placed on an inner bottom surface 21 of the leg portion 17. Screw insertion holes 47 and 49 for screw fastening to a plurality of mating busbars (not shown) are formed in an upper portion of the second body portion 43 and the second bent piece 45, respectively.

Positions of the screw insertion holes 37, 47 and 39, 49 in the first busbar 31 and the second busbar 41 are set according to positions of the corresponding mating busbars in consideration of ease of assembly and securing clearance with a component in a battery pack.

Therefore, the first busbar 31 has, when viewed from the front, an inverted L-shape in which an upper portion of the first body portion 33 is widened in order to secure a screw fastening surface. The second busbar 41 has, when viewed from the front, an inverted L-shape in which a lower portion of the second body portion 43 and the second bent piece 45 are widened in order to secure a screw fastening surface.

Screw through holes 23 and 27 are respectively formed in the first inner wall surface 14 of the case body 13 and the inner bottom surface 20 of the leg portion 17 to correspond to the screw insertion holes 37 and 39. Screw through holes 25 and 29 are respectively formed in the second inner wall surface 16 and the inner bottom surface 21 of the leg portion 17 to correspond to the screw insertion holes 47 and 49.

A partition wall 12 that secures an insulation distance between the first busbar 31 and the second busbar 41 is provided on the second inner wall surface 16 of the case body 13 and the inner bottom surface 21 of the leg portion 17.

Next, an operation of the busbar arrangement structure according to the present embodiment described above will be described.

In the inter-stack arrangement module 1 including the busbar arrangement structure according to the present embodiment, the second inner wall surface 16 is farther from the outer wall surface 19 of the case body 13 than the first inner wall surface 14, and the step 18 is formed at the boundary between the second inner wall surface 16 and the first inner wall surface 14.

The first busbar 31 has, when viewed from the front, the inverted L-shape in which the upper portion of the first body portion 33 is widened and the screw insertion hole 37 for screw fastening to the mating busbar is formed. The second busbar 41 has, when viewed from the front, an inverted L-shape in which the second bent piece 45 is widened and the screw insertion hole 49 for screw fastening to the mating busbar is formed.

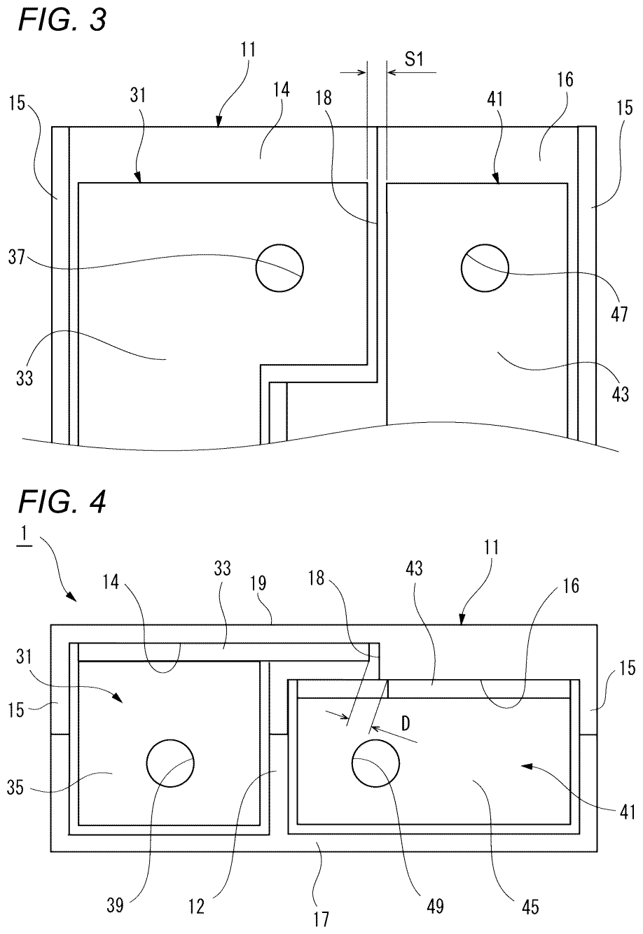

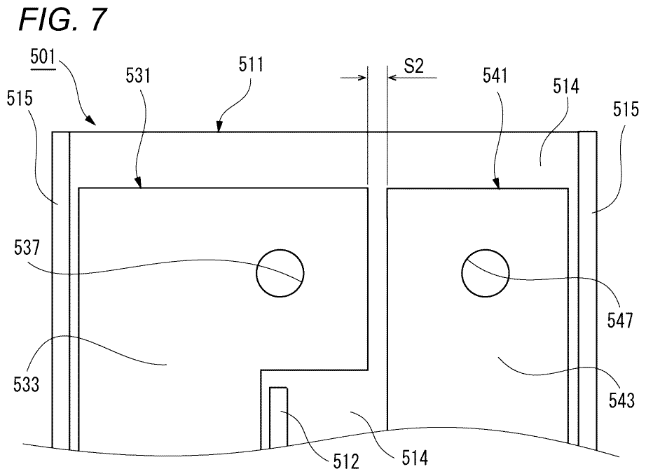

Therefore, as shown in FIG. 3, an apparent distance S1 viewed from the front between upper adjacent portions of the first busbar 31 arranged along the first inner wall surface 14 in the busbar arrangement case 11 and the second busbar 41 arranged along the second inner wall surface 16 is the same as a distance S2 that is an insulation distance between upper adjacent portions of the first busbar 531 and the second busbar 541 in the inter-stack arrangement module 501 in the related art shown in FIG. 7. The positions and intervals of the screw insertion holes 37 and 47 in the first busbar 31 and the second busbar 41 are also the same as positions and intervals of the screw insertion holes 537 and 547 in the first busbar 531 and second busbar 541 in the related art.

That is, according to the inter-stack arrangement module 1 including the busbar arrangement structure according to the present embodiment, as shown in FIG. 4, an insulation distance D between the first busbar 31 arranged along the first inner wall surface 14 and the second busbar 41 arranged along the second inner wall surface 16 is widened by the step 18 formed at the boundary between the second inner wall surface 16 and the first inner wall surface 14, and a sufficient insulation distance can be secured.

In the inter-stack arrangement module 1 including the busbar arrangement structure according to the present embodiment, the height of the step 18 is larger than the plate thickness of the first body portion 33 of the first busbar 31.

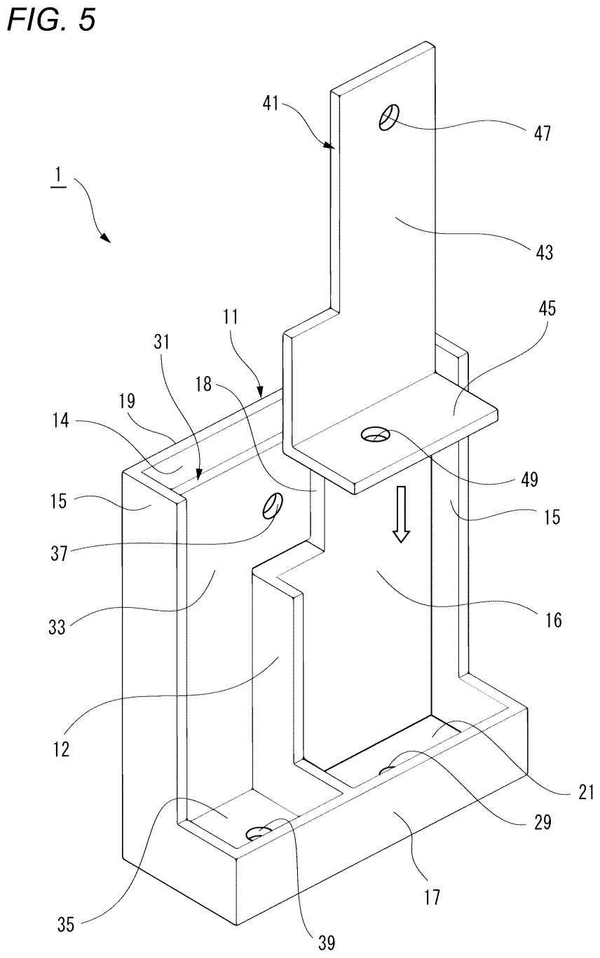

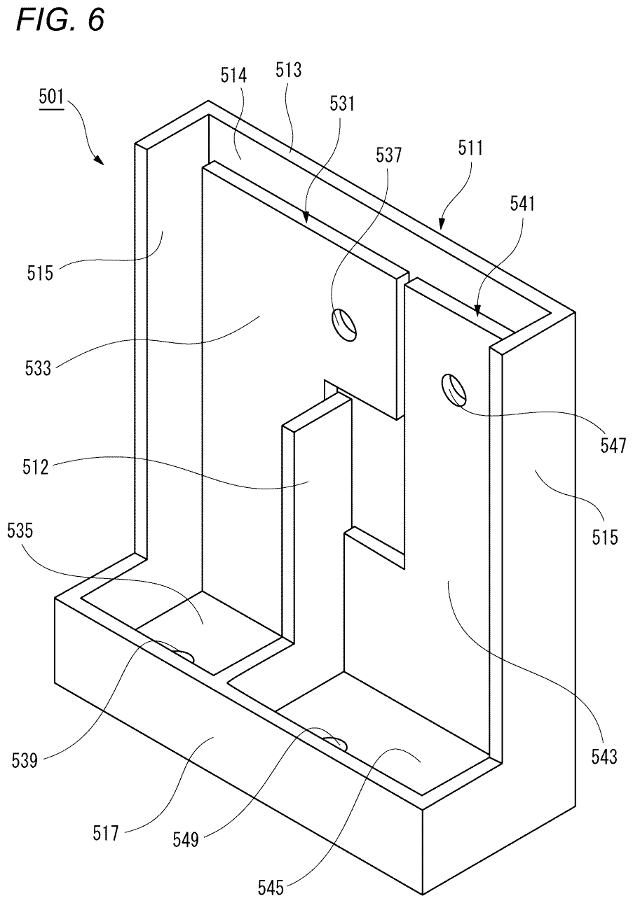

Therefore, as shown in FIG. 5, even when the second busbar 41 is to be inserted from above in a state in which the first busbar 31 is already arranged along the first inner wall surface 14 in the busbar arrangement case 11, the second bent piece 45 of the second busbar 41 does not interfere with the first busbar 31. Therefore, the first busbar 31 and the second busbar 41 can be arranged without being limited by the arrangement order, and assembly workability is improved.

Therefore, according to the busbar arrangement structure according to the present embodiment, the insulation distance D between the adjacent first busbar 31 and the second busbar 41 can be easily secured.

The present disclosure is not limited to the embodiment described above, and can be appropriately modified, improved, or the like. In addition, the materials, shapes, sizes, numbers, arrangement positions, and the like of the components in the embodiments described above are freely selected and are not limited as long as the present disclosure can be implemented.

Here, features of the busbar arrangement structure according to the embodiment of the present disclosure described above are briefly summarized and listed in the following [1] to [3]. [1] A busbar arrangement structure including:
a busbar arrangement case (11) including a rectangular plate-shaped case body (13), side walls (15) that extend in an upper-lower direction and that are provided on both side edges of the case body (13) in a manner of being perpendicular to the side edges, and a box-shaped leg portion (17) provided on a lower end of the case body (13);
a first busbar (31) including a first body portion (33) configured to be arranged along a first inner wall surface (14) of the case body (13), and a first bent piece (35) that is provided on a lower end of the first body portion (33) in a manner of being perpendicular to the lower end and that is configured to be placed on an inner bottom surface (20) of the leg portion (17), the first busbar (31) being inserted into the busbar arrangement case (11) from above; and
a second busbar (41) including a second body portion (43) configured to be arranged along a second inner wall surface (16) that is provided beside the first inner wall surface (14) extending in the upper-lower direction in a manner of being side by side with the first inner wall surface (14), and a second bent piece (45) that is provided on a lower end of the second body portion (43) in a manner of being perpendicular to the lower end and that is configured to be placed on an inner bottom surface (21) of the leg portion (17), the second busbar (41) being inserted into the busbar arrangement case (11) from above, in which
a step (18) is formed at a boundary between the first inner wall surface (14) and the second inner wall surface (16) that is farther from an outer wall surface (19) of the case body (13) than the first inner wall surface (14).

According to the busbar arrangement structure described in the above [1], an insulation distance (D) between the first busbar (31) arranged along the first inner wall surface (14) and the second busbar (41) arranged along the second inner wall surface (16) is widened by the step (18) formed at the boundary between the second inner wall surface (16) and the first inner wall surface (14), and a sufficient insulation distance can be secured.

[2] The busbar arrangement structure according to the above [1], in which
the first busbar (31) has, when viewed from the front, an inverted L-shape in which an upper portion of the first body portion (33) is widened and a screw insertion hole (37) for screw fastening to a mating busbar is formed, and
the second busbar (41) has, when viewed from the front, an inverted L-shape in which the second bent piece (45) is widened and a screw insertion hole (49) for screw fastening to a mating busbar is formed.

According to the busbar arrangement structure described in the above [2], a sufficient insulation distance between the widened upper portion of the first body portion (33) and the second body portion (43) is secured by the step (18).

[3] The busbar arrangement structure according to the above [2], in which
a height of the step (18) is larger than a plate thickness of the first body portion (33).

According to the busbar arrangement structure described in the above [3], even when the second busbar (41) is to be inserted from above in a state in which the first busbar (31) is already arranged along the first inner wall surface (14) in the busbar arrangement case (11), the second bent piece (45) of the second busbar (41) does not interfere with the first busbar (31). Therefore, the first busbar (31) and the second busbar (41) can be arranged without being limited by the arrangement order, and assembly workability is improved.

What is claimed is:

1. A busbar arrangement structure comprising:
a busbar arrangement case including a rectangular plate-shaped case body, side walls that extend in an upper-lower direction and that are provided on both side edges of the case body in a manner of being perpendicular to the side edges, and a box-shaped leg portion provided on a lower end of the case body;
a first busbar including a first body portion configured to be arranged along a first inner wall surface of the case body, and a first bent piece that is provided on a lower end of the first body portion in a manner of being perpendicular to the lower end and that is configured to be placed on an inner bottom surface of the leg portion, the first busbar being inserted into the busbar arrangement case from above; and
a second busbar including a second body portion configured to be arranged along a second inner wall surface that is provided beside the first inner wall surface extending in the upper-lower direction in a manner of being side by side with the first inner wall surface, and a second bent piece that is provided on a lower end of the second body portion in a manner of being perpendicular to the lower end and that is configured to be placed on an inner bottom surface of the leg portion, the second busbar being inserted into the busbar arrangement case from above,
wherein a step is formed at a boundary between the first inner wall surface and the second inner wall surface that is farther from an outer wall surface of the case body than the first inner wall surface.

2. The busbar arrangement structure according to claim 1,
wherein the first busbar has, when viewed from the front, an inverted L-shape in which an upper portion of the first body portion is widened and a screw insertion hole for screw fastening to a mating busbar is formed, and
wherein the second busbar has, when viewed from the front, an inverted L-shape in which the second bent piece is widened and a screw insertion hole for screw fastening to a mating busbar is formed.

3. The busbar arrangement structure according to claim 2,
wherein a height of the step is larger than a plate thickness of the first body portion.
